(19) United States
(12) Patent Application Publication
(10) Pub. No.: US 2019/0288637 A1
(43) Pub. Date: Sep. 19, 2019

(54) METHOD OF INTEGRATING SOLAR PANELS IN THE ROOF SUBSTRATE STRUCTURE

(71) Applicant: Better Natural, LLC, Fairfield, IA (US)

(72) Inventor: Joachim CLAES, Fairfield, IA (US)

(21) Appl. No.: 16/353,829

(22) Filed: Mar. 14, 2019

Related U.S. Application Data
(60) Provisional application No. 62/778,149, filed on Dec. 11, 2018.
(60) Provisional application No. 62/643,232, filed on Mar. 15, 2018.

(51) Int. Cl. H02S 20/25

(52) U.S. Cl. CPC H02S 20/25

(57) ABSTRACT

A method for integrating photovoltaic cells into the roof substrate structure is described. Panels including photovoltaic cells are attached to a board which the board has a length less than the length of the panels. Photovoltaic cells are placed in columns with gaps in between, so that the width of a defined number of columns plus the width of an equal number of gaps in between matches the distance in between the centers of the roof trusses on which the boards plus panels will be attached. After the addition of a waterproof felt plus additional beams on the trusses, the panels with the boards attached are then attached to the trusses. Decorative members are attached to the panels to provide moisture resistance and aesthetic appeal.

### CROSS-REFERENCE TO RELATED APPLICATIONS

The present application claims priority to provisional patent application 62/643,232 which was filed on Mar. 15, 2018; and priority to provisional application 62/778,149 which was filed on Dec. 11, 2018, and both are hereby expressly incorporated by reference in their respective entirety.

### BACKGROUND OF THE INVENTION

The present invention relates to a method to place and integrate solar panels into and onto a roof substrate structure. Traditionally photovoltaic (PV) panels are placed on top of existing roof structures, which is not aesthetically pleasing and can be quite expensive. A typical roof structure with PV panels on top of the roof structure usually has the following layers: roof substrate (wooden sheathing), waterproof felt, roof cover and PV panels.

Several companies have attempted to integrate solar cells into roof tiles, however, these roof tiles are expensive. Furthermore, connecting the plurality of individual cells into one grid is complicated. As such, the previous attempts and proposed solutions do not have a significant effect on the related costs.

The present invention describes a way where the roof substrate, roof cover and PV cells are integrated as one panel that creates the look of individual solar roof tiles. The panel can then easily be connected to other panels in one electrical grid. These panels are less expensive to manufacture than regular solar panels, as they don't require aluminum framing or expensive hardened glass covers. Additionally, the panels are significantly cheaper to install. For only a slightly higher cost than the cost to install a roof substrate, the invention allows a user to install the substrate, roof cover and PV system.

It is therefore an object of the invention to provide a method to integrate PV cells into a substrate of a roof.

It is a further object of the invention to provide a method to integrate PV cells into a substrate of a roof that can be performed quickly and at a reduced cost over the prior art.

### SUMMARY OF THE INVENTION

The present invention utilizes panels of solar cells or PV cells mounted within a cover and then mounted on a board. The panels are then mounted to beams which are mounted to trusses of a roof. The PV cells are arranged in rows and columns with a specific width in between the rows and columns depending on the application and the distance between the trusses and the width of the trusses.

During installation of the panels, an overlap is created to ensure waterproofing where one of the bottom of the panels meets the top of another panel. After installation of the panels, decorative members are attached between panels forming a vertical structure to ensure waterproofing between panels. The user of the invention can produce different patterns depending on the number and type of decorative members selected by the user.

### BRIEF DESCRIPTION OF THE DRAWING

FIG. 1 is a top view of PV cells connected in columns that are further connected to one another to form a continuous circuit;

FIG. 2 is a perspective view of the panels on trusses;

FIG. 3 is a top view of the PV cells with a cover;

FIG. 4 is a perspective view of a panel on a board;

FIG. 5 is a perspective view of a panel and board with a junction box;

FIG. 6 is a perspective view of a roof with a covering and a beam;

FIG. 7 is a perspective view of the beam showing overlaps;

FIG. 8 is a perspective view showing the overlap of panels;

FIG. 9 is a perspective view of decorative member placed on a panel;

FIG. 10 is a perspective view of a pattern of decorative members;

FIG. 11 is a perspective view of a particular pattern;

FIG. 12 is a perspective view of a second particular pattern;

FIG. 13 is a perspective view of a completed roof with a non-rectangular shape.

### DESCRIPTION OF THE PREFERRED EMBODIMENT OF THE INVENTION

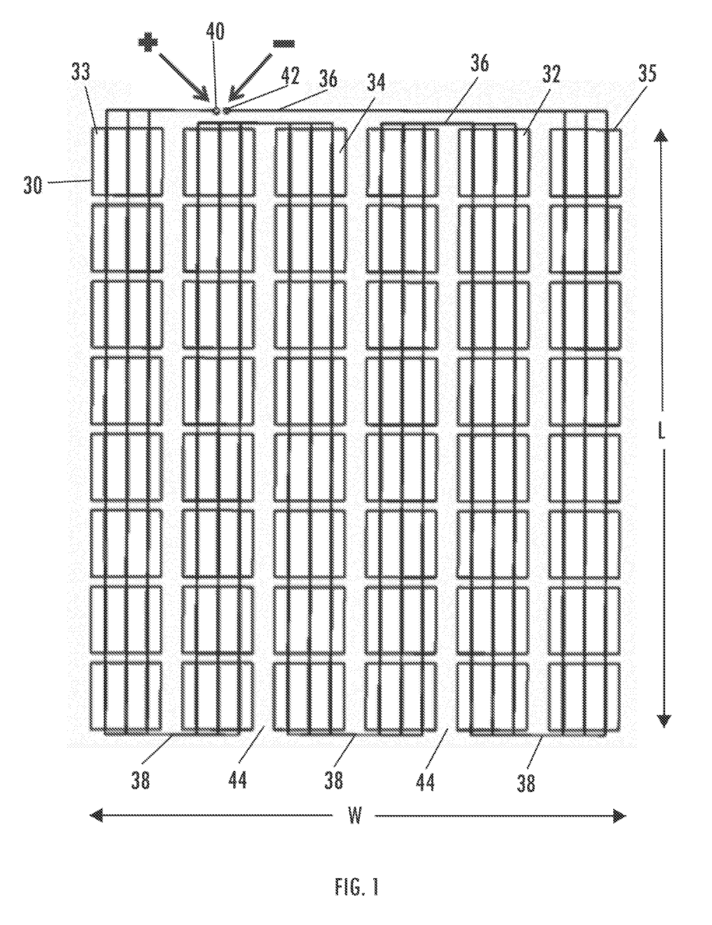

Referring now to the figures, FIG. 1 shows rows 30 going left to right and columns 32 going up and down of solar cells or photovoltaic cells (PV cells) 34. The individual PV cells 34 (or areas that capture the solar energy, in case of printed PV cells) are placed in a circuit 36 so that this entire circuit 36 can be connected to another circuit 36, from another panel 54, through one single dual connection (the typical positive and negative connections on solar panels). The PV cells 34 are placed so that the PV cells 34 form one continuous column 32 of cells 34, which is then connected to the next column 32 of cells 34, via connecting member 38 forming one circuit 36, with the end connections 40 and 42 coming from the start of the first column 33 and the end of the last column 35.

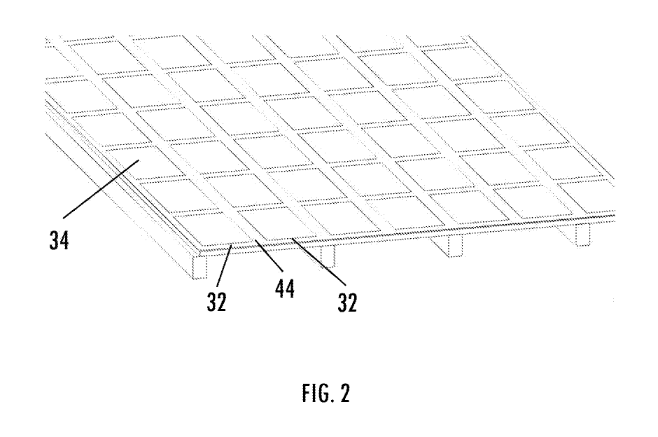

A gap 44 is located in between columns 32. Preferably, the width of each gap 44 is calculated such that the width of a defined number of PV cells 34 plus the width of a number of gaps 44 in between the columns 32 will equal the width in between roof trusses on which the panels 54 will be placed plus the width of each roof truss. For example, most roof trusses are spaced at either 16″ or 24″ between the centers of two trusses. If we take columns 32 of PV cells 34 that are six inches wide by six inches long, then we place the PV cells 34 in columns 32 with two inches in between the columns 32. Now the total of the width of the columns 32 plus the gaps 44 is eight inches, and the gaps will exactly match trusses that are placed either sixteen or twenty-four inches on center, as shown in FIG. 2.

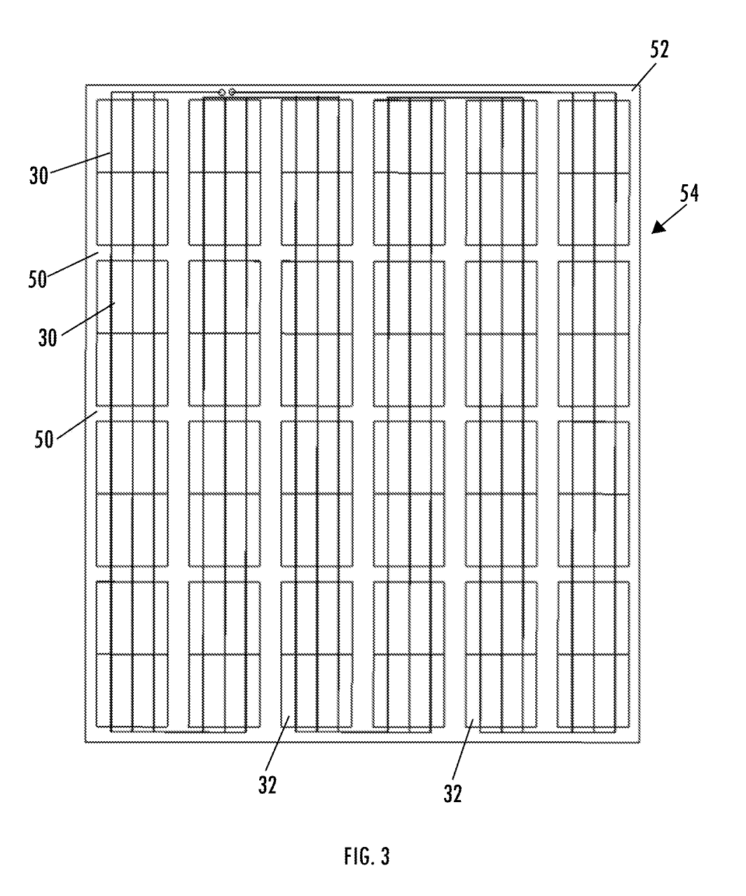

FIG. 3 demonstrates a second gap 50 between rows 30 of the PV cells 34. The second gap 50 can be either in between every PV cell 34, or in between every two PV cells 34, or every three or four PV cells.

As also shown in FIG. 3, in case of use of traditional PV cells 34, a cover 52 is placed over the PV cells 34 with a material that allows a user to cut and drill through the cover 52. Typically the material of the cover 52 will be UV resistant plastic, rather than traditional PV hardened glass. Whereas traditional solar panels have the layers of a backsheet, an encapsulant, the PV cells, an encapsulant and a hardened glass cover; the invention utilizes panels 54 having a backsheet, an encapsulant, the PV cells, an encapsulant and a cover made from a material that can be drilled and/or cut, in case of the use of traditional PV cells. Other PV cell technologies may have different layers, but the cell layout remains the same. The ends of the circuit 36 stick out of the back of the panel 54.

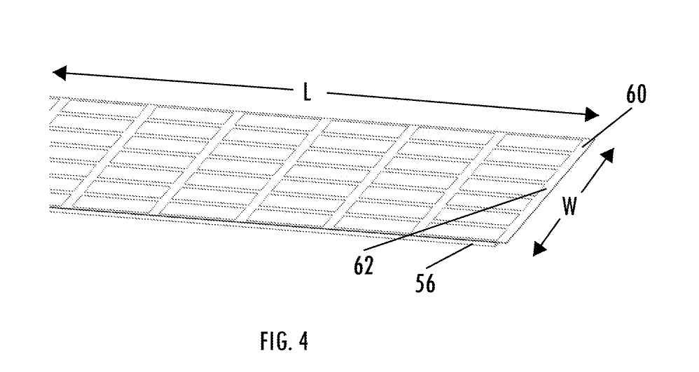

The cover 52 encapsulates the PV cells 34 and is slightly longer than the width and length of the circuit 36 of PV cells 34. At a maximum, preferably the cover 52 extends a distance that is half the distance between the columns 32 of PV cells 34 on each side along the length of the columns 32, and no more than the distance in between the PV cells 34 inside the rows 30 on each side at the ends of the rows as shown in FIGS. 3 and 4.

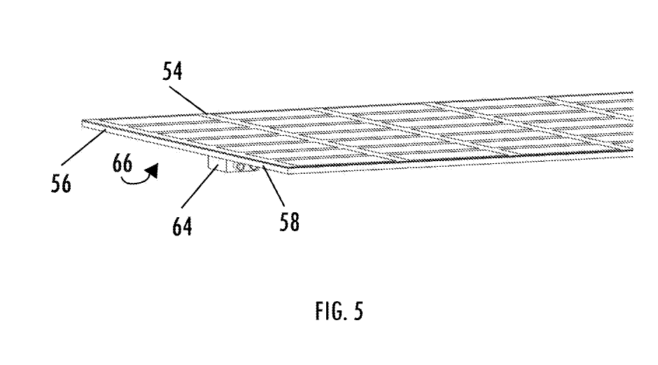

As shown in FIGS. 4 and 5, the panel 54 is then placed on a board 56, which is preferably one of the following: oriented strand board, plywood, or magnesium oxide board or a board from any other material that is strong enough to act as traditional sheathing on a roof. The board 56 is cut such that the board 56 has the same width as the panel 54, however, the board 56 is cut such that the length of the board 56 is slightly shorter than the panel 54 as best shown in FIG. 4. The panel 54 is placed such that the top edge 58 of the panel 54 aligns with the top of the board 56, but the bottom edge 60 of the panel 54 extends from the board 56 to form a first portion 62. The first portion 62 should be no longer than the distance between the PV cells 34 in the rows 30.

As shown in FIG. 5, holes are drilled in the board 56 such that end connections 40 and 42 of the circuit 36 can go through the board 56. A junction box 64 is placed at the back 66 of the board 56, through which the panels 54 can be connected to one another.

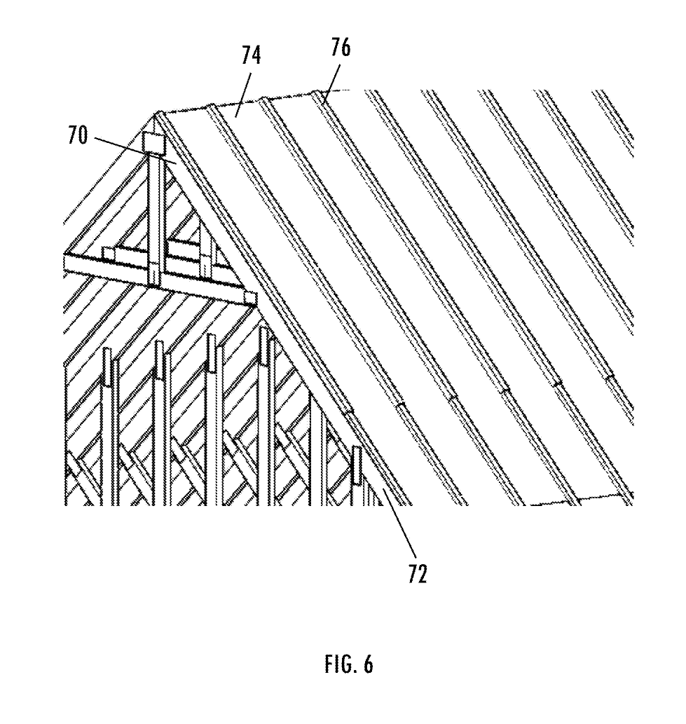

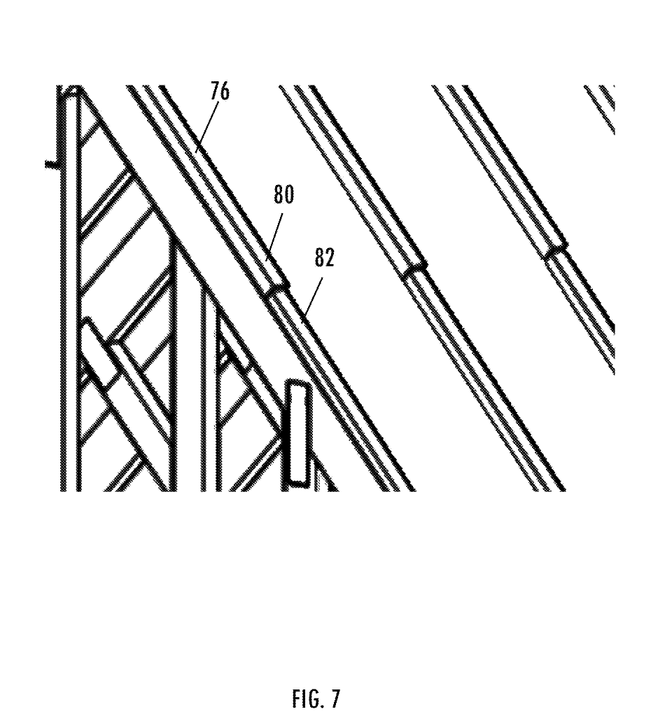

As shown in FIG. 6, prior to the placement of panels 54 that are mounted on boards 56 on a roof 70, the roof trusses 72 are covered with a waterproof material 74, preferably felt. After the waterproof material 74 is placed, a beam member 76 is attached to the waterproof material 74 at the location where a roof truss 72 is located below the waterproof material 74. The beam member 76 preferably has the same width as the roof truss 72, and has a thickness that is slightly thicker than the junction box 64. The beam members 76 are as long as the panels 54 but are slightly thicker at a first end 80 than at a second end 82 as shown in FIG. 7. The difference in thickness between the first end 80 and the second end 82 is equal to the thickness of the panel 54 that is placed on top of the boards 56. Accordingly, given a panel 54 with PV cells 34 and the different layers of covers 52 with a four mm thickness, and a junction box 64 with a twenty mm thickness, the beam members could have a twenty-two mm thickness at the second end 82, and a twenty-six mm thickness on the first end 80.

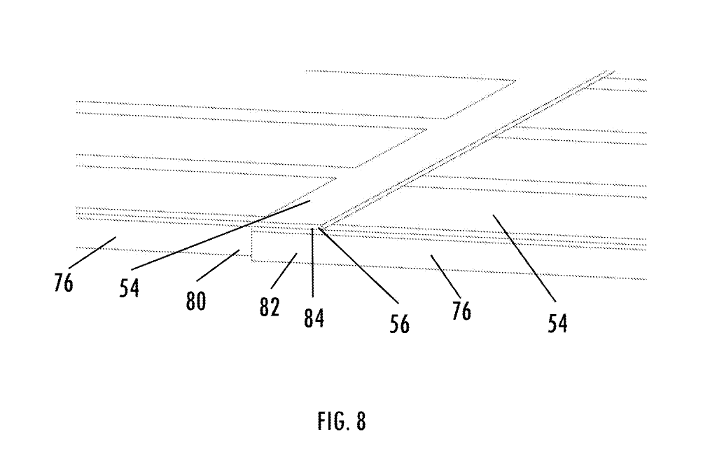

As shown in FIG. 8, the panels 54 mounted on boards 56 are placed on top of the beam members 76, such that the panels 54 form an overlap area 84. The overlap area 84 creates a waterproof overlap between the panels 54 along the length of the panel 54.

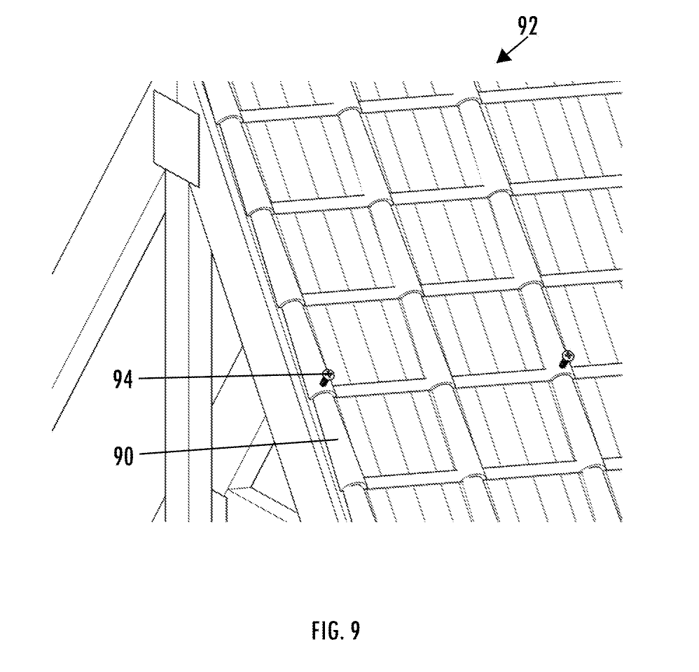

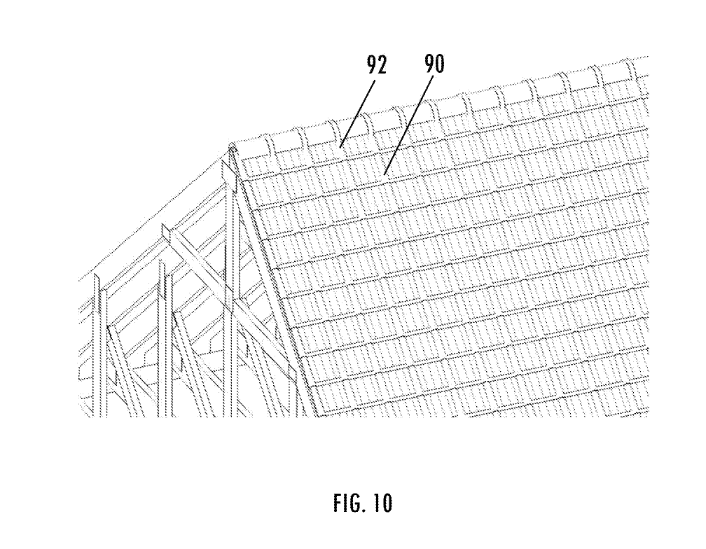

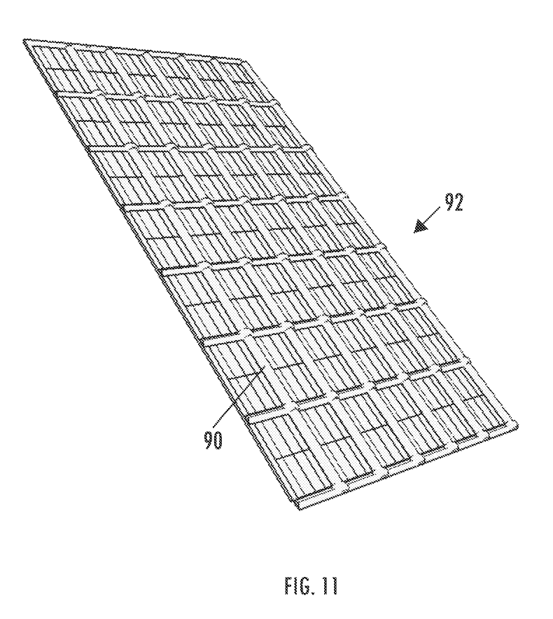

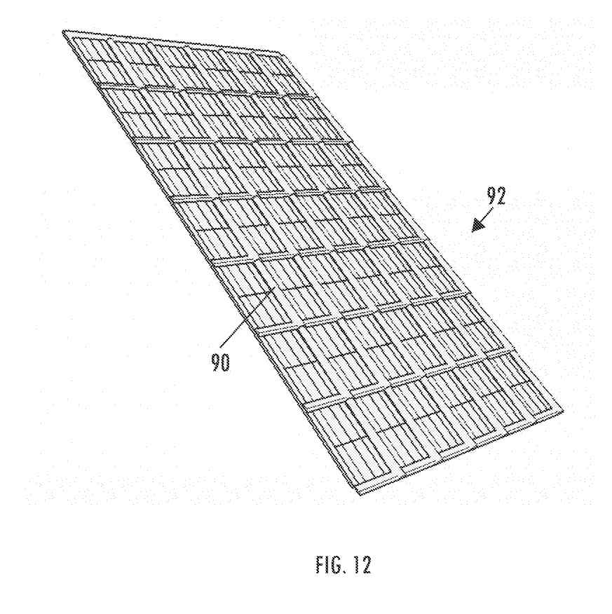

As shown in FIG. 9, decorative members 90 form a pattern 92 on top of the panels 54, creating the look of individual roof tiles. Preferably, the pattern 92 matches the shape that is created by the gaps between the rows of cells, and the gaps between the cells in the columns. Screws 94 go through the decorative members 90, the panels 54 and the boards 56, the beam members 76, the waterproof material 74, and into the roof trusses 72. Alternatively, the panels 54 and the boards 56 can be screwed into the roof trusses 72 first, and then attach the decorative members 90. An added benefit of the decorative members 90 is that the pattern 92 will also cover the area where two panels 54 meet along their widths, creating a waterproof overlap along the length of the panel 54. FIGS. 10-12 show variations of patterns 92 that can be utilized.

In a gap between the waterproof felt and the panels, cables can be run to connect the junction boxes 64 of the panels 54 to each other.

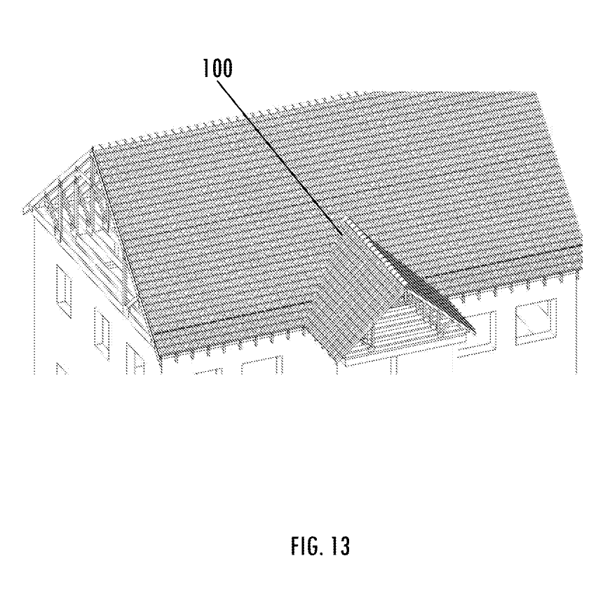

In practicing the method of the invention, at the bottom and top of the roof, an opening is left so that air can circulate through the space in between the waterproof material 74 and the panels 54 mounted on boards 56. This will create a self-cooling mechanism. The panels 54 warming up will cause the air underneath the panels 54 to rise, drawing fresh cool air from the bottom.

Wherever there is an irregular roof shape such as area 100 in FIG. 13, the panels 54 and boards 56 can be cut. In order to become more efficient at cutting, special panels wherein the solar cells are replaced by another material that looks similar but can be easily cut. Accordingly, the roof has the same design throughout.

Having thus described the invention in connection with the preferred embodiments thereof, it will be evident to those skilled in the art that various revisions can be made to the preferred embodiments described herein without departing from the spirit and scope of the invention. It is my intention, however, that all such revisions will be included within the scope of the following claims.

What is claimed is as follows:

1. A method for integrating solar panels into a roof, the roof having trusses, comprising the steps of:
arranging a plurality of solar cells in rows;
arranging the plurality of solar cells in columns;
connecting the plurality of solar cells in at least one electrical circuit;
covering the plurality of solar cells with a cover;
the covered plurality of solar cells forming a panel;
attaching a board to a bottom of the panel;
attaching the panel to at least one truss of the roof.

2. The method of claim 1, wherein:
the panel is longer than the board;
wherein a first portion of the panel extends past the board.

3. The method of claim 2, wherein:
there is a gap between each column of solar cells.

4. The method of claim 3, wherein:
each gap has a width;
a width of the gap is calculated so that the sum of a width of a defined number of columns of solar cells plus a width of a number of gaps in between the columns is configured to equal a distance between centers of roof trusses on which the panel will be placed.

5. The method of claim 4, further comprising the step of:
connecting the panel to a second panel;
wherein a first end of the second panel goes under the first portion of the first panel.

6. The method of claim 5, wherein:
a second gap between each row of solar cells.

7. The method of claim 6, wherein:
a width of the second gap is at least as wide as a width of the first portion of the first panel.

8. The method of claim 7, further comprising the step of:
attaching at least one decorative member to a top of the cover.

9. The method of claim 8, wherein:
the at least one decorative member is placed over the gap between columns.

10. A method for integrating solar panels into a roof, the roof having trusses, comprising the steps of:
arranging a plurality of solar cells in rows;
arranging the plurality of solar cells in columns;
connecting the plurality of solar cells in at least one electrical circuit;
covering the plurality of solar cells with a cover;
the covered plurality of solar cells forming a panel;
attaching a board to a bottom of the panel;
attaching at least one beam to one of the trusses;
attaching the panel to the at least one beam.

11. The method of claim 10, wherein:
the panel is longer than the board;
wherein a first portion of the panel extends past the board.

12. The method of claim 11, wherein:
there is a gap between each column of solar cells.

13. The method of claim 12, wherein:
each gap has a width;
a width of the gap is calculated so that the sum of a width of a defined number of columns of solar cells plus a width of a number of gaps in between the columns is configured to equal a distance between centers of roof trusses on which the panel will be placed.

14. The method of claim 13, further comprising the step of:
connecting the panel to a second panel;
wherein a first end of the second panel goes under the first portion of the first panel.

15. The method of claim 14, wherein:
a second gap between each row of solar cells.

16. The method of claim 15, wherein:
a width of the second gap is at least as wide as a width of the first portion of the first panel.

17. The method of claim 16, further comprising the step of:
attaching at least one decorative member to a top of the cover.

18. The method of claim 17, wherein:
the at least one decorative member is placed over the gap between columns.

19. The method of claim 18, wherein:
the beams have a first end and a second end;
the first end has a first thickness;
the second end opposite the first end;
the second end has a second thickness;
the first thickness of the first end is lesser than the second thickness of the second end.

20. The method of claim 19, wherein:
the second thickness of the second end is the same as the sum of the first thickness and a thickness of the panel.
